(19) United States
(12) Patent Application Publication
(10) Pub. No.: US 2002/0083045 A1
(43) Pub. Date: Jun. 27, 2002

(54) Information retrieval processing apparatus and method, and recording medium recording information retrieval processing program

(75) Inventors: Masao Utiyama, Tokyo (JP); Masaki Murata, Tokyo (JP); Hitoshi Isahara, Tokyo (JP)

Correspondence Address: STAAS & HALSEY LLP, 700 11TH STREET, NW, SUITE 500, WASHINGTON, DC, 20001, US

(73) Assignee: Communications Research Laboratory, Independent Administrative Institution, Tokyo (JP)

(21) Appl. No.: 10/017,316

(22) Filed: Dec. 18, 2001

(30) Foreign Application Priority Data
Dec. 27, 2000 (JP) 2000-396764

(51) Int. Cl. G06F 7/00

(52) U.S. Cl. 707/1

(57) ABSTRACT

An information retrieval processing apparatus has a unit accepting positional information, in a case that the positional information designating a range to extract a retrieval key on an electronic character information displayed on an output device is input, a unit specifying a predetermined retrieval key extracting range from the electronic character information displayed on the output device on a basis of the positional information, and a unit performing the information retrieval based on the specified retrieval key extracting range and outputting the retrieved result.

### BACKGROUND OF THE INVENTION

1. Field of the Invention

The present invention relates to an information retrieval processing apparatus, an information retrieval processing method, and a recording medium that records an information retrieval processing program, and more particularly to an information retrieval processing apparatus, an information retrieval processing method, and a recording medium that records an information retrieval processing program, in which the information retrieval processing apparatus can implement the information retrieval processing method in simple manner in an access or retrieval system for electronic information in the World Wide Web and the electronic encyclopedia or the like.

2. Description of the Related Art

As the conventional retrieval technique of electronic information, there is a keyword retrieval technique for making the retrieval employing a keyword input by a user. Also, there is a similar topic retrieval technique for retrieving a document similar to a document being currently perused.

For example, there are following reference documents:

(1) Reference document 1; Ken Aratani, Tatsuhiko Tunoda, Takumi Oishi, Makoto Nagao, “A technique for retrieving the relevant articles of newspaper with frequency and position of word”, Information Processing Society of Japan, Treatise Journal, 1997, Vol. 38, No. 4, pp 855-862; and

(2) Reference document 2: Hitoshi Isahara, Hiromi Kosaku, Kiyotaka Uchimoto, Masaki Murata, Hiroshi Kabuta, Masahiro Mikami, Noriyuki Nishimata, Makoto Takahashi, “Developing a news reader with an information retrieval method based on topics relevancy”, Information Technology Promotion Agency, Japan, the 19-th technology release treatises, Oct. 11-12, 2000.

The information retrieval technique for retrieving the electronic document by means of the computer has been significant along with the development of the electronic document and information society.

Most of the information retrieval systems require the user to input a keyword. However, in the keyword retrieval, it takes a lot of time to input the keyword, and the input keyword is limited within a range of keywords the user can think of. Accordingly, the significance of the input keyword may be mistaken in some cases, in which if less important keyword is chosen and input, the retrieval noise may be increased, resulting in the problem with degraded retrieval precision.

Also, in the similar topic retrieval technique, the retrieval is only allowed at the document level, whereby there is the limit that a document similar to the content represented by a part of document can not be retrieved. Accordingly, if there is the inconsistency in similarity between the entire document and the content represented by a part of document, the problem arises that the retrieval precision is degraded.

### SUMMARY OF THE INVENTION

The present invention has been achieved to solve the above-mentioned problems, and it is an object of the invention to provide an information retrieval processing apparatus for effecting the keyword retrieval only by clicking on or dragging a portion of the electronic information displayed on the screen which the user wants to know in more detail simply with one touch in retrieving the electronic information.

Also, it is an object of the invention to provide an information retrieval processing method for effecting the keyword retrieval only by clicking on or dragging a portion of the electronic information displayed on the screen which the user wants to know in more detail simply with one touch in retrieving the electronic information.

Further, it is an object of the invention to provide a recording medium that records an information retrieval processing program for operating the information retrieval processing apparatus for effecting the keyword retrieval only by clicking on or dragging a portion of the electronic information displayed on the screen which the user wants to know in more detail simply with one touch in retrieving the electronic information.

The information retrieval processing apparatus of the invention can retrieve information on a basis of electronic character information. The apparatus comprises an output device, accepting means for accepting positional information, in a case that the positional information designating a range to extract a retrieval key on the electronic character information displayed on the output device is input, specifying means for specifying a retrieval key extracting range from the electronic character information displayed on the output device on a basis of the positional information, and performing and outputting means for performing the information retrieval based on the specified retrieval key extracting range and outputting a result of the information retrieval.

Also, the information retrieval processing method of the invention can retrieve information on a basis of electronic character information. The method comprises accepting positional information, in a case that the positional information designating a range to extract a retrieval key on the electronic character information displayed on an output device is input, specifying the retrieval key extracting range from the electronic character information displayed on the output device on the basis of the positional information, and performing the information retrieval based on the specified retrieval key extracting range to output a result of the information retrieval.

Also, the recording medium of the invention records a program to retrieve information on a basis of electronic character information. The program causes the computer accepting positional information, in a case that the positional information designating a range to extract a retrieval key on the electronic character information displayed on an output device is input, specifying a retrieval key extracting range from the electronic character information displayed on the output device on the basis of the positional information, and performing the information retrieval based on the specified retrieval key extracting range to output a result of the information retrieval.

That is, the present invention involves extracting a retrieval key from the electronic character information, and retrieving the information on a basis of the extracted retrieval key, in such a way as to accept the positional information, in a case that the positional information designating a range for extracting the retrieval key on the electronic character information displayed on an output device is input, specify a predetermined retrieval key extracting range, perform the information retrieval based on the specified retrieval key extracting range and output the retrieved result. In the processing steps, the retrieval key extracting range is defined as the range containing a predetermined number of characters, words or lines before, after or before and after the character of the positional information input by the user. In the case that the positional information input by the user designates a start position or an end position of the retrieval key extracting range, the retrieval key extracting range is defined as the input range from the start position to the end position.

With the conventional technique, when the information retrieval was made in terms of the retrieval key, the user had to input one or more retrieval keys from the keyboard. However, in this invention, the user only needs to simply click on or drag a portion of the word or topic of interest in the electronic document being currently perused with a pointing device such as a mouse, and thereby can retrieve or peruse the other electronic information relevant with that portion simply.

The program for realizing each processing means on the computer can be stored in an appropriate recording medium such as a portable medium memory, a semiconductor memory, or a hard disk that can be read by the computer.

### BRIEF DESCRIPTION OF THE DRAWINGS

FIG. 1 is a block diagram showing a configuration of an information retrieval processing apparatus according to an embodiment of the present invention.

FIG. 2 is a processing flowchart of an information retrieval processing method according to the embodiment of the invention.

FIG. 3 is a view showing an input example and a display example of the retrieved result.

FIG. 4 is a view showing an input example and a display example of the retrieved result.

FIG. 5 is a view showing an example of a user setting screen for setting up a retrieval key extracting condition.

FIGS. 6A to 6D are views showing examples of a retrieval key extracting range, in which

FIG. 6A shows an example of setting up the range (list of character strings) by dragging,

FIG. 6B shows an example of setting up the range (rectangular range) by dragging,

FIG. 6C shows an example of setting up the range of 20 characters before and after the clicked part, and

FIG. 6D shows an example of setting up the range of three lines before the clicked part.

### DETAILED DESCRIPTION OF THE PREFERRED EMBODIMENTS

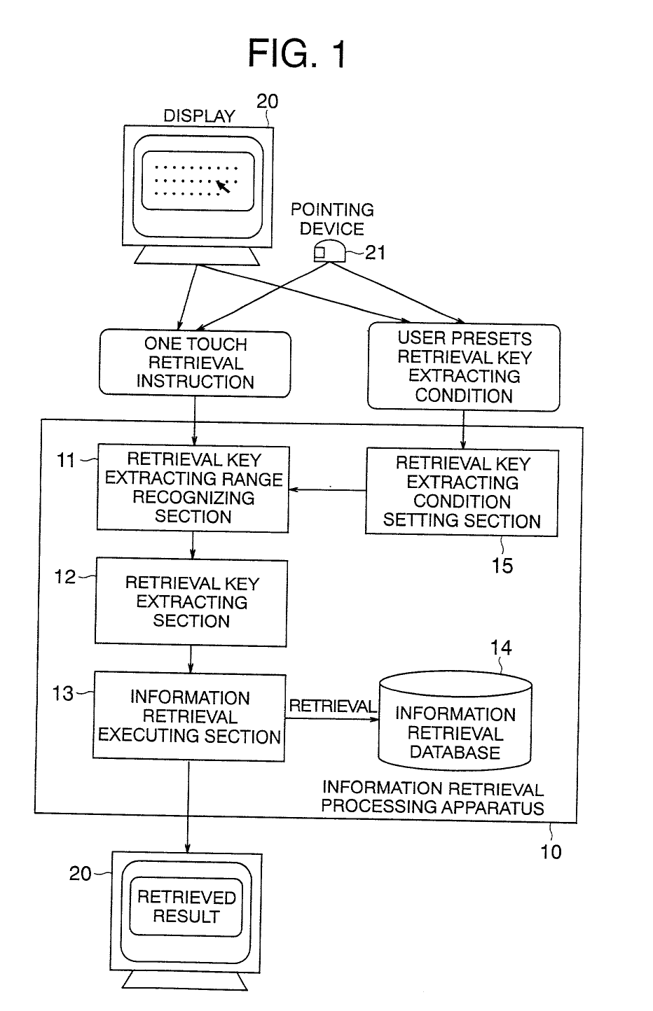

The preferred embodiments of the present invention will be described below by reference to the accompanying drawings. FIG. 1 shows a configuration example of an information retrieval processing apparatus according to an embodiment of the invention. The information retrieval processing apparatus 10 comprises a retrieval key extracting range recognizing section (or unit) 11, a retrieval key extracting section (or unit) 12, an information retrieval executing section (or unit) 13, an information retrieval database 14, and a retrieval key extracting condition setting section (or unit) 15. The information retrieval database 14 may be provided outside the information retrieval processing apparatus 10. Also, the information retrieval executing section 13 may execute the retrieval employing another apparatus connected via the network.

The information retrieval processing apparatus 10 in this embodiment has a display 20 as an output device, and a pointing device 21 such as a mouse as an input device. The pointing device 21 may be in any form so far as it can designate the position on the display screen.

The retrieval key extracting range recognizing section (or means) 11 accepts the positional information for designating the retrieval key extracting range for the electronic character information displayed on the display 20, and then specifies the retrieval key extracting range from the character information displayed on the display 20 on a basis of the accepted positional information. The retrieval key extracting section (or means) 12 extracts one or more retrieval keys from the retrieval key extracting range specified in the retrieval key extracting range recognizing section 11. The information retrieval executing section (or means) 13 retrieves the information retrieval database 14, employing the retrieval key extracted by the retrieval key extracting section 12, and outputs the retrieved result. The retrieval key extracting condition setting section (or means) 15 sets up the extraction condition for specifying the retrieval key extracting range from the positional information on the display screen in terms of an input given in advance from the user.

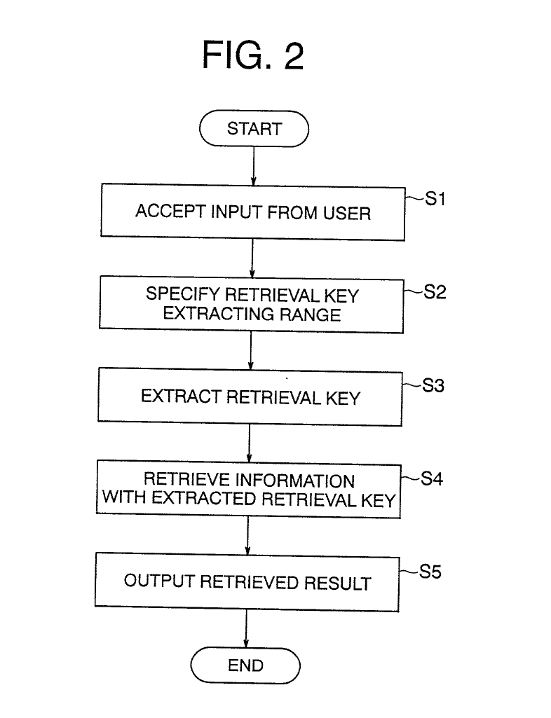

FIG. 2 shows a processing flow of the information retrieval processing apparatus 10 as shown in FIG. 1. First of all, the retrieval key extracting range recognizing section 11 accepts an input of the positional information to designate the range for extracting the retrieval key on the electronic document (step S1), and specifies the retrieval key extracting range on the electronic document on a basis of the accepted positional information (step S2).

The positional information is specified by clicking on or dragging with the pointing device 21 such as mouse, for example, a portion that the user wants to know in more detail on the displayed electronic document. There are following ways for designating the range. Where X is a positive integer.

(1) The range is designated as X characters before, after or before and after the clicked part.

(2) The range is designated as X lines before, after or before and after the clicked part.

(3) The range is designated as X main words before, after or before and after the clicked part.

(4) The range is designated as paragraphs before and after a paragraph containing the clicked part that are separated by the null line.

(5) The range is designated as a portion before and after the clicked part separated by the period or punctuation mark.

(6) The range is designated as the dragged part.

For example, in a case that the range is designated as 40 characters before and after a part which the user has clicked on, the user firstly accepts an input of the clicked part (positional information), and then specifies a total of 81 characters including a clicked character and the characters before and after the clicked character as the retrieval key extracting range. Also, in a case that the range is designated as 20 characters before and after a part which the user has clicked on, the user firstly accepts an input of the clicked part, then extracts 20 characters before and after the input part through the morphological analysis, and defined them as the retrieval key extracting range.

Next, the retrieval key extracting section 12 extracts the retrieval key from the specified retrieval key extracting range. First of all, the independent or dependent word is classified from the retrieval key extracting range through the morphological analysis, and the noun (or verb as needed) is extracted from among the classified independent words to employ the extracted noun as the retrieval key. Further, only the important noun such as a technical term may be extracted as the retrieval key from among the nouns. Whether or not the important word is the retrieval key can be determined in such a manner that the word often arising in any document irrespective of the kind of document is not important, and the word arising partially in the specific document is important. This can be determined by the use of a word dictionary storing the statistical information regarding the occurrence frequency of word in the typical documents. The importance as the retrieval key may be judged by referring to a word dictionary storing the word attributes indicating the proper noun or technical term. Other known word extracting process may be employed to extract the retrieval key.

Next, the information is retrieved from the information retrieval database 14 according to the retrieval key extracted by the information retrieval executing section 13 (step S4), and the retrieved result is output (step S5). The retrieval of information may be implemented by utilizing an existing retrieval server via the network.

Also, the following Robertson's expression may be employed to make the retrieval process in which all the nouns extracted by the retrieval key extracting section 12 are employed as the retrieval key, thereby offering a solution at higher precision:

S(d)=ΣTF(d,t)/(TF(d,t)+1)*IDF(t)

(Σ denotes the summation of keyword t)

Where S(d) is the score of an article d, TF(d, t) is the occurrence frequency of keyword t in the article d, and IDF(t) is the inverse of the number of articles in which the keyword t arises.

The following reference document 3 is offered. Robertson's document can be tracked from this reference document 3, which is incorporated as a reference in this specification:

(3) Reference document 3; Masaki Murata, Sei Ba, Kiyotaka Uchimoto, Hiromi Kosaku, Masao Uchiyama, Hitoshi Isahara, “Information retrieval using the positional information and field information”, Natural Language Processing (Natural Language Association Journal), April 2000, Vol. 7, No. 2, p.141 to 160.

The keyword arising in various documents is regarded as unimportant, but has a smaller value of IDF(t) that is the inverse of the number of articles and may be used by multiplying a small weight in the above expression. The value of S(d) in the above expression is calculated with the obtained keyword as t, and the result is presented to the user in the order of articles having higher S(d).

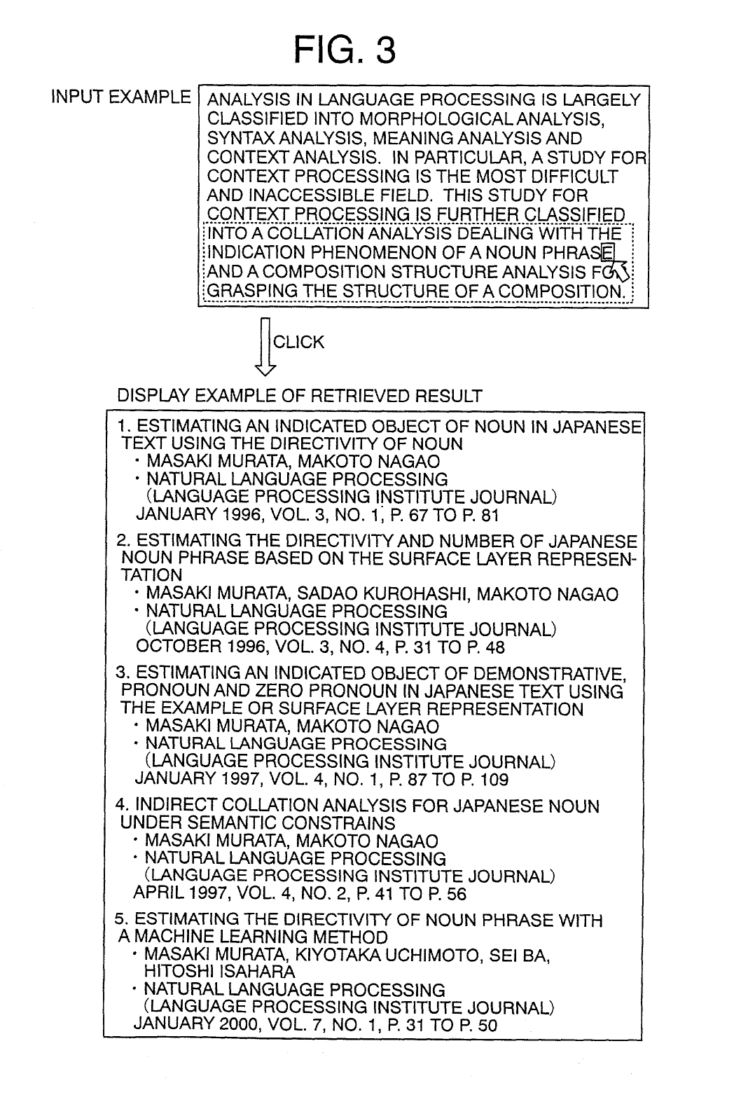

A specific example will be described below in which a part of text in the electronic article is retrieved from a database having the article book information registered. FIG. 3 shows an input example of retrieval source and a display example of the retrieved results extracted from the input example.

The input example as shown in FIG. 3 is a part of the electronic technical article displayed on the display 20. Suppose that the user sees this displayed article and is interested in the “collation analysis”. Thus, the user moves the cursor near the “collation analysis” in the displayed document, and clicks on it.

Herein, it is supposed that the designation of the range of 20 characters before and after the clicked part (a total of 41 characters) is set as the condition of extracting the range of retrieval key, for example. Then, the retrieval key extracting range recognizing section 11 senses that the cursor is located at a portion “collation”, accepts its positional information, and specifies 20 characters before and after the “collation” (a total of 41 characters) as the retrieval key extracting range. The specified range is the “the study for processing is the sentence structure analysis for grasping the collation analysis dealing with the indication phenomenon of noun phrase and the sentence structure”.

The retrieval key extracting section 12 performs the morphological analysis for the retrieval key extracting range to extract the noun alone. The extracted words include “processing, study, noun, phrase, indication, phenomenon, collation, analysis, sentence, structure, sentence, structure, analysis”, with a group of these words as the retrieval key. On a basis of a prepared retrieval key extracting dictionary, “noun”, “indication”, “phenomenon”, “collation”, and “analysis” are determined as the important retrieval key from the group of words extracted, and “noun phrase” and “indication phenomenon” may be employed as the compound word.

The information retrieval executing section 13 performs the retrieval processing for the article book information database (information retrieval database 14), employing the retrieval key received from the retrieval key extracting section 12 and outputs the retrieved result. A display example of the retrieved result is shown in FIG. 3. A list of book information of corresponding article is displayed as the retrieval processing result. In this example, the data of retrieval source is the article, and the retrieval source is the book information. However, the retrieval can be made even if the data of retrieval source to extract the retrieval key and the data of retrieval object are of different format as in this example.

The information may be retrievable on the World Wide Web (WWW), but not the information retrieval database 14 where the retrieval object is at specific location. In the case of the information retrieval on the WWW, the retrieval result is displayed in a list format as shown in FIG. 3 or a simpler format, and the contents of article may be accessed through the hyper link by clicking on the retrieved result.

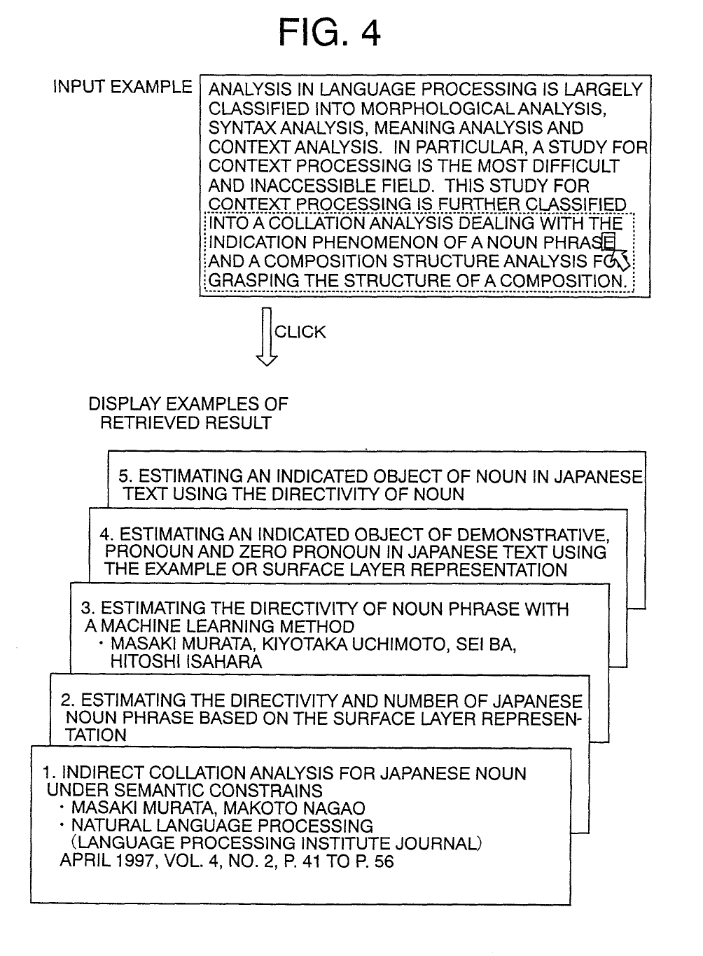

A retrieval example using the Robertson's expression will be set forth below by reference to an example of FIG. 4. Suppose that an input example is the same as the example of FIG. 3. In the specified retrieval key extracting range “the study for processing is the sentence structure analysis for grasping the collation analysis dealing with the indication phenomenon of noun phrase and the sentence structure”, “noun”, “indication” and “collation” do not frequently appear in various documents, whereby IDF(t) has a high value in the Robertson's expression. Therefore, the book information containing these words gets a high score and is presented to the user. A display example of the retrieved result is shown in FIG. 4.

In some cases, the phrase level such as “sentence structure” is also employed as the keyword. In such a case, the “sentence structure” is unlikely to occur in various articles, and IDF(t) becomes larger, with the possibility that a large amount of book information containing “sentence structure” is output by mistake. However, when all the documents read by the user are retrieved using the key, other keywords such as morphological morpheme and syntax may be contained, with the possibility that a lot of unnecessary article is taken, whereby it is thought that the items relating to “collation” can be retrieved at full precision in the extent that the article somewhat relating to the “sentence structure” is taken.

On the other hand, a case that the user wants to consult the dictionary more correctly is considered. At this time, the designation by drag may be employed. If a part of interest is dragged, the dragged range is only the “collation analysis dealing with the indication phenomenon of noun phrase”, for example. In this case, if the morphological analysis is made to take out the noun, “noun, phrase, indication, phenomenon, collation, analysis” results, without keyword such as “sentence structure”, and if the retrieval is performed, the article relating to “collation” can be retrieved more correctly.

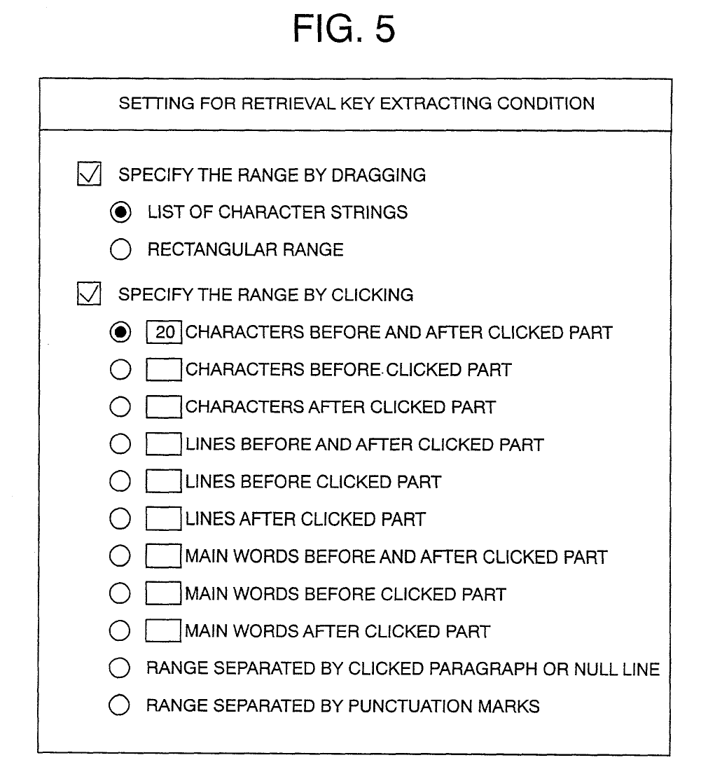

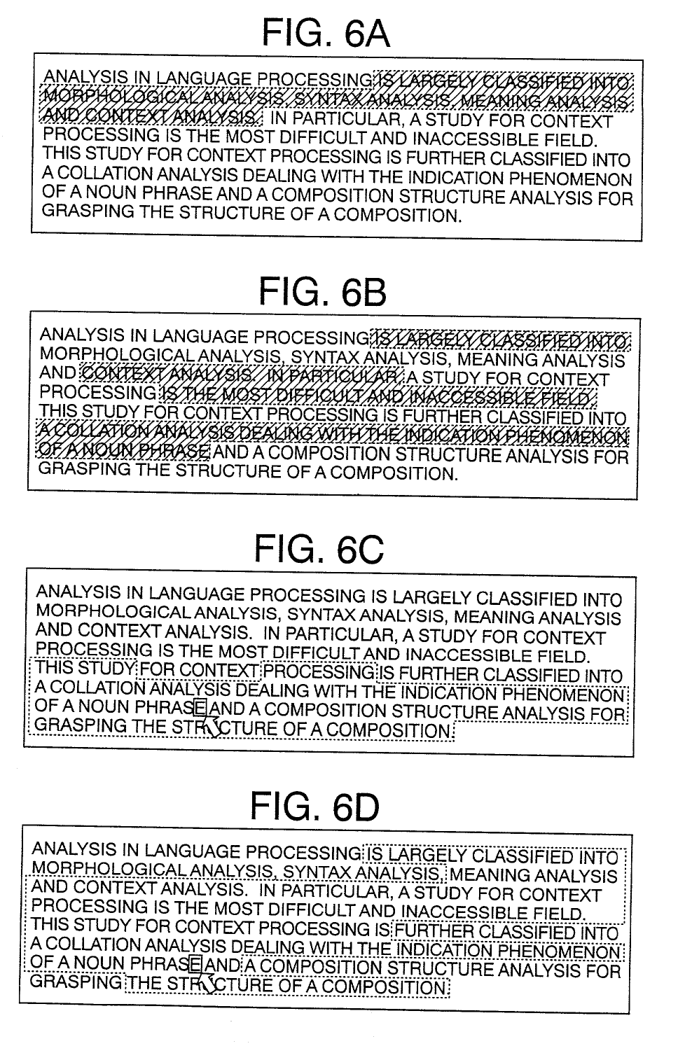

FIG. 5 shows an example of a user setting screen for setting the retrieval key extracting condition, and FIG. 6 shows an example of the retrieval key extracting range. In this embodiment, the user can set the retrieval key extracting condition beforehand on the user setting screen as shown in FIG. 5 that is displayed by the retrieval key extracting condition setting section 15 of FIG. 1. First of all, whether the range is designated by dragging, or by clicking can be selected by clicking on a check box.

Further, when the range is designated by dragging, whether an array of character strings or a rectangular range is designated can be chosen. For example, in a case that the range is designated by dragging and the array of character strings is chosen, suppose that the range from “morphological analysis” to “large classification” is dragged as shown in FIG. 6A. Then, the retrieval key extracting range is “largely classified into morphological analysis, syntax analysis, meaning analysis, and context analysis”. Also, in a case that the range is designated by dragging and the rectangular range is chosen, the range from “context analysis” to “collation analysis” is dragged, and the retrieval key extracting range is the rectangular range containing “context analysis” at upper left corner and “collation analysis” at lower right corner.

In a case that “20 characters before and after the clicked part” (number 20 is set by the user) is selected in designating the range by clicking, the user clicks on a character “collation” in the retrieval source data, as shown in FIG. 6C, whereby a total of 41 characters containing 20 characters before and after the clicked part is recognized as the retrieval key extracting range (range enclosed by the dotted line). FIG. 6D shows an example of the retrieval key extracting range (range enclosed by the dotted line) when “three lines before the clicked part” is selected in designating the range by clicking. The cases of other setting are the same.

The retrieval key extracting condition setting section 15 can be called from the menu when the user needs it. Thereby, the retrieval key extracting condition setting section 15 displays the user setting screen as shown in FIG. 5, and the setting information of the retrieval key extracting condition set by the user is notified to the retrieval key extracting range recognizing section 11. Since this setting information is preserved, the user may change the setting information on the user setting screen as shown in FIG. 5, as needed.

A difference between the methods with the conventional technique and this embodiment will be set forth employing an example of making access to the Internet information such as WWW by the browser. When the user is reading a certain home page, it is supposed that the user wants to search a page describing in more detail a portion of the page being currently read.

At this time, with the conventional technique of keyword retrieval, it is required that the user picks up the main word (content word) from that portion of page being read currently and searched, and inputs it into an existing retrieval engine for keyword retrieval to make the retrieval. Also, with the conventional technique of retrieving the similar topics, the retrieval is enabled only in a unit of document (here a unit of page in the home page), whereby the main word (content word) is taken out and retrieved from the whole page being read currently. Accordingly, the possibility is higher that unnecessary keyword is contained, as compared with taking out of a portion of the page being read currently.

In contrast, with the retrieval method of this embodiment, only by clicking on a part of the page being read currently and desired to know in detail with the pointing device, the main word (content word) is taken out from the natural language sentence in a predetermined range around that part, or only by dragging that part of the page desired to know in more detail with the pointing device, the main word (content word) is taken out from the natural language sentence in the dragged part, whereby the information on the WWW is retrieved. Accordingly, there is no need for the user to designate the keyword every time, unlike the conventional keyword retrieval, and this design is very user friendly. Also, the keyword is not taken out from the whole document, but is automatically taken out from a portion of notice of the page, unlike the conventional retrieval of similar topics, whereby the retrieval can be performed at high precision.

When the retrieval is made as shown in FIG. 3, with the conventional keyword retrieval, the character string such as “collation” or “collation analysis” may be input as the retrieval key, but only with the retrieval key of “collation” or “collation analysis”, the retrieved result that the user wants to know can not pick up sufficiently. At this time, even if the user wants to add other retrieval key, it is difficult to designate and add an appropriate word as the retrieval key without knowledge about the relevant words.

On the contrary, with the retrieval method of this embodiment, the word such as “noun phrase” or “indication phenomenon” that is present neat the character “collation” can be automatically extracted as the retrieval key only by clicking on a part near the character “collation”. Generally, word groups relevant semantically appear closely in the document, and therefore the word such as “collation”, “noun phrase” or “indication phenomenon” is chosen as the retrieval key, whereby the retrieval with precision can be implemented. Thereby, the user can easily obtain the retrieved result without knowing whether or not the words such as “collation”, “noun phrase” and “indication phenomenon” are semantically relevant, and does not leak the desired information.

As described above, with the present invention, the retrieval of information is made by accepting the positional information designated by the user from the electronic character information of retrieval source, designating the range for extracting the retrieval key from its positional information, and automatically extracting the retrieval key is from the designated range of retrieval source. Thereby, the user only needs to instruct the position of the information to be retrieved in the electronic document on the display screen, and there is the effect that the operation load can be relieved from the user inputting the retrieval key.

Also, the retrieval of information is made by extracting the retrieval key from not the similarity of the whole document, but a partial range of the document, whereby the retrieved result at high precision can be output even though a part of the document of retrieval source has a different trend from the contents of the whole document.

What is claimed is:

1. An information retrieval processing apparatus to retrieve information on a basis of electronic character information, the apparatus comprising:
an output device;
accepting means for accepting positional information, in a case that the positional information designating a range to extract a retrieval key on the electronic character information displayed on the output device is input;
specifying means for specifying a retrieval key extracting range from the electronic character information displayed on the output device on a basis of the positional information; and
performing and outputting means for performing the information retrieval based on the specified retrieval key extracting range and outputting a result of the information retrieval.

2. An information retrieval processing apparatus according to claim 1, wherein the specifying means defines the retrieval key extracting range as the range containing a predetermined number of characters, words or lines before, after or before and after the positional information, the range of paragraphs indicated by the positional information or the range delimited by the punctuation mark containing the characters of the positional information.

3. An information retrieval processing apparatus according to claim 1, wherein the specifying means defines the retrieval key extracting range as an input range from a start position to an end position in a case that the positional information designates the start position and the end position of the retrieval key extracting range.

4. An information retrieval processing apparatus according to claim 1, wherein the performing and outputting means further comprises:
extracting means for extracting one or more retrieval keys from the retrieval key extracting range;
an information retrieval database; and
retrieving and outputting means for retrieving the information retrieval database by using the one or more retrieval keys and outputting the result of the information retrieval.

5. An information retrieval processing apparatus according to claim 1, further comprising:
condition setting means for setting an extracting condition to designate the retrieval key extracting range from the positional information, the extracting condition being input by an user.

6. An information retrieval processing apparatus according to claim 1, further comprising:
an input device to input the positional information designating a range to extract a retrieval key on the electronic character information displayed on the output device, the input device being a pointing device.

7. An information retrieval processing method to retrieve information on a basis of electronic character information, the method comprising:
accepting positional information, in a case that the positional information designating a range to extract a retrieval key on the electronic character information displayed on an output device is input;
specifying the retrieval key extracting range from the electronic character information displayed on the output device on a basis of the positional information; and
performing the information retrieval based on the specified retrieval key extracting range to output a result of the information retrieval.

8. An information retrieval processing method according to claim 7, wherein the specifying includes defining the retrieval key extracting range as the range containing a predetermined number of characters, words or lines before, after or before and after the positional information, the range of paragraphs indicated by the positional information or the range delimited by the punctuation mark containing the characters of the positional information.

9. An information retrieval processing method according to claim 7, wherein the specifying includes defining the retrieval key extracting range as an input range from a start position to an end position, in a case that the positional information designates the start position and the end position of the retrieval key extracting range.

10. An information retrieval processing method according to claim 7, wherein the performing further comprises:
extracting one or more retrieval keys from the retrieval key extracting range; and
retrieving an information retrieval database by using the one or more retrieval keys to output the result of the information retrieval.

11. An information retrieval processing method according to claim 7, further comprising:
setting condition to set an extracting condition to designate the retrieval key extracting range from the positional information, the extracting condition being input by an user.

12. A recording medium recording an information retrieval processing program to retrieve information on a basis of electronic character information, wherein the program causes the computer to execute:
accepting positional information, in a case that the positional information designating a range to extract a retrieval key on the electronic character information displayed on an output device is input;
specifying a retrieval key extracting range from the electronic character information displayed on the output device on a basis of the positional information; and
performing the information retrieval based on the specified retrieval key extracting range to output a result of the information retrieval.
